(19) United States
(12) Patent Application Publication
(10) Pub. No.: US 2025/0151095 A1
(43) Pub. Date: May 8, 2025

(54) MANAGING SIDELINK FEEDBACK TO A BASE STATION

(71) Applicant: Lenovo (Singapore) Pte. Limited, Singapore (SG)

(72) Inventors: Karthikeyan Ganesan, Kronberg Im Taunus (DE); Alexander Golitschek Edler von Elbwart, Darmstadt (DE); Joachim Löhr, Wiesbaden (DE); Prateek Basu Mallick, Dreieich (DE); Vijay Nangia, Woodridge, IL (US); Ravi Kuchibhotla, Chicago, IL (US)

(73) Assignee: Lenovo (Singapore) Pte. Limited, Singapore (SG)

(21) Appl. No.: 18/838,072

(22) PCT Filed: Feb. 5, 2023
(86) PCT No.: PCT/IB2023/051018

§ 371 Date: Aug. 13, 2024

Related U.S. Application Data
(60) Provisional application No. 63/309,935, filed on Feb. 14, 2022.

(51) Int. Cl. H04W 72/40; H04L 1/1812; H04L 1/1867

(52) U.S. Cl. CPC H04W 72/40; H04L 1/1812; H04L 1/1887; H04L 1/1893

(57) ABSTRACT

Various aspects of the present disclosure relate to a user equipment (UE) that acquires, from a base station, a sidelink (SL) grant that includes a channel occupancy time (COT) for part of an unlicensed spectrum allowing the acquiring UE to transmit SL control and data information to a secondary UE. The acquiring UE can also share the COT with the secondary UE, allowing the secondary UE to transmit SL control and data to the acquiring UE or another UE. The acquiring UE performs clear channel assessment (CCA) on one or more SL resources associated with the SL grant. The UE returns an SL hybrid automatic repeat request (HARQ) feedback to the base station based at least in part on a status of the CCA.

### RELATED APPLICATION

This application claims priority to U.S. Patent Application Ser. No. 63/309,935 filed Feb. 14, 2022 entitled “Managing Sidelink Feedback to a Base Station,” the disclosure of which is incorporated by reference herein in its entirety.

### TECHNICAL FIELD

The present disclosure relates to wireless communications, and more specifically to managing sidelink feedback.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Some wireless communications systems support channel occupancy time (COT) sharing between a UE and a base station. Such COT sharing allows a UE or base station to acquire a COT and share the COT with the other of the UE and the base station.

### SUMMARY

The present disclosure relates to methods, apparatuses, and systems that support managing sidelink feedback to a base station. A UE can acquire, from a base station, a sidelink (SL) grant that includes a COT for part of an unlicensed spectrum allowing the acquiring UE to transmit SL control and data information to a secondary UE. The acquiring UE can also share the COT with the secondary UE, allowing the secondary UE to transmit SL control and data to the acquiring UE or another UE. The acquiring UE performs clear channel assessment (CCA), such as listen before talk (LBT), on one or more SL resources associated with the SL grant. The UE returns an SL hybrid automatic repeat request (HARQ) feedback to the base station based at least in part on a status of the CCA. In returning the SL HARQ feedback to the base station, the acquiring UE accounts for various different situations, such as the CCA failing on the one or more SL resources, a physical sidelink feedback channel (PSFCH) not being received from the secondary UE before the SL HARQ feedback is to be transmitted to the base station, and so forth. By utilizing the described techniques, the acquiring UE is able to provide feedback to the base station based on the status of the CCA that allows the base station to respond properly to the feedback and allows the acquiring UE to use the SL grant.

Some implementations of the method and apparatuses described herein may include wireless communication at a device (e.g., a UE), and the device receives receive, from a base station, first control signaling indicating a first SL grant having one or more associated SL resources; perform CCA for the one or more associated SL resources; and transmit, to the base station, second control signaling based at least in part on a status of the CCA.

In some implementations of the method and apparatuses described herein, the device performs, in response to the one or more SL resources not being included in the first SL grant or the one or more SL resources being outside a remaining channel occupancy (CO) determination, autonomous resource selection to obtain a resource for the first SL grant. Additionally or alternatively, the second control signaling comprises a SL HARQ feedback, and, in response to a PSFCH not being received from a second apparatus via the one or more SL resources before a physical uplink control channel (PUCCH) resource, the device transmits the SL HARQ feedback to the base station, a discontinuous transmission (DTX) in the SL HARQ feedback. Additionally or alternatively, the second control signaling comprises a SL HARQ feedback, and the device, in response to a PSFCH not being received from a second apparatus via the one or more SL resources before a PUCCH resource is to transmit the SL HARQ feedback to the base station, transmits a non-acknowledgement (NACK) in the SL HARQ feedback; receives, from the base station, a third control signaling indicating a second SL grant; and ignores, in response to the PSFCH being received from the second apparatus via the one or more SL resources after the SL HARQ feedback is transmitted to the base station, the second SL grant. Additionally or alternatively the second control signaling comprises a first SL HARQ feedback in a first PUCCH resource indicating a first status of the CCA if the CCA failed for the one or more SL resources, or a second SL HARQ feedback in a second PUCCH resource indicating a second status of the CCA if a decoding failure of SL data occurred. Additionally or alternatively, the first SL grant identifies one or more of the associated SL resources, a COT sharing indicator, or a remaining CO duration. Additionally or alternatively, the second control signaling includes a SL HARQ feedback. Additionally or alternatively, the second control signaling comprises a SL HARQ feedback, and the device, in response to the CCA failing for the one or more SL resources, includes an acknowledgment (ACK) in the SL HARQ feedback; and performs autonomous resource selection to obtain a resource for the first SL grant. Additionally or alternatively, the second control signaling comprises a SL HARQ feedback, and the device, in response to the CCA failing for the one or more SL resources, includes a NACK in the SL HARQ feedback; and receives, from the base station in response to the SL HARQ feedback, a second SL grant. Additionally or alternatively, the device, in response to the first SL grant identifying a COT sharing indicator and the one or more associated SL resources, performs Cat 2 LBT as the CCA. Additionally or alternatively, the device, in response to the first SL grant not identifying the one or more associated SL resources, performs autonomous resource selection to obtain a resource for the first SL grant within a remaining CO duration. Additionally or alternatively, the second control signaling comprises a SL HARQ feedback, and the device, in response to a PSFCH not being received from a second apparatus via the one or more SL resources before a PUCCH resource is to transmit the SL HARQ feedback to the base station, transmits a NACK in the SL HARQ feedback; receives, from the base station, a third control signaling indicating a second SL grant; and transmits a new transmission, in response to the PSFCH not being received from the second apparatus via the one or more SL resources, to the second apparatus via one or more SL resources associated with the second SL grant. Additionally or alternatively, the second control signaling comprises a SL HARQ feedback, and the device, in response to a PSFCH not being received from a second apparatus via the one or more SL resources before a first PUCCH resource is to transmit the SL HARQ feedback to the base station, transmits, in a second PUCCH resource, the SL HARQ feedback indicating a delay in reception of the PSFCH. Additionally or alternatively, the device: receives, from the base station, a non-numerical SL HARQ feedback indicator; receives, from the base station after receiving the non-numerical SL HARQ feedback indicator, a trigger to request the SL HARQ feedback; and transmits, to the base station in response to the trigger, the second control signaling. Additionally or alternatively, the device: receives, from the base station as part of the first control signaling, an indication of a starting of a CO duration for transmission on the one or more associated SL resources; and perform, during a time gap indicated by the starting of the CO duration, autonomous resource selection to obtain a resource for the first SL grant.

Some implementations of the method and apparatuses described herein may include wireless communication at a device (e.g., a base station), and the device transmits, to a UE, first control signaling indicating a first SL grant having one or more associated SL resources; and receives, from the UE, second control signaling based at least in part on a status of CCA performed by the UE for the one or more associated SL resources.

In some implementations of the method and apparatuses described herein, the second control signaling comprises a first SL HARQ feedback in a first PUCCH resource indicating a first status of the CCA if the CCA failed for the one or more SL resources, or a second SL HARQ feedback in a second PUCCH resource indicating a second status of the CCA if a decoding failure of SL data occurred. Additionally or alternatively, the device: transmits, to the UE, a non-numerical SL HARQ feedback indicator; transmits, to the UE after transmitting the non-numerical SL HARQ feedback indicator, a trigger to request the SL HARQ feedback; and receives, from the UE in response to the trigger, the second control signaling.

### BRIEF DESCRIPTION OF THE DRAWINGS

Various aspects of the present disclosure for managing sidelink feedback to a base station are described with reference to the following Figures. The same numbers may be used throughout to reference like features and components shown in the Figures.

FIG. 1 illustrates an example of a wireless communications system that supports managing sidelink feedback to a base station in accordance with aspects of the present disclosure.

FIG. 2 illustrates a system that supports managing sidelink feedback to a base station in accordance with aspects of the present disclosure.

FIG. 3 illustrates an example of using a separate PUCCH resource.

FIG. 4 illustrates an example of a block diagram of a device (e.g., a UE) that supports managing sidelink feedback to a base station in accordance with aspects of the present disclosure.

FIG. 5 illustrates an example of a block diagram of a device (e.g., a base station) that supports managing sidelink feedback to a base station in accordance with aspects of the present disclosure.

FIGS. 6, 7, 8, 9, 10, and 11 illustrate flowcharts of methods that support managing sidelink feedback to a base station in accordance with aspects of the present disclosure.

### DETAILED DESCRIPTION

Implementations of managing sidelink feedback to a base station are described, such as related to a UE acquiring, from a base station, a SL grant that includes a COT for part of an unlicensed spectrum allowing the acquiring UE to transmit SL control and data information to a secondary UE. The acquiring UE can also share the COT with the secondary UE, allowing the secondary UE to transmit SL control and data to the acquiring UE or another UE. The acquiring UE performs CCA, such as Cat 2 LBT or Cat 4 LBT, on one or more SL resources associated with the SL grant. The UE returns a SL HARQ feedback to the base station based at least in part on a status of the CCA. In returning the SL HARQ feedback to the base station, the acquiring UE accounts for various different situations, such as the CCA failing on the one or more SL resources, a PSFCH not being received from the secondary UE before the SL HARQ feedback is to be transmitted to the base station, and so forth.

For example, in situations in which CCA fails on all of the one or more SL resources, the UE may return SL HARQ feedback that is an ACK in a PUCCH resource and switch to autonomous resource allocation mode to select further SL resources, return SL HARQ feedback that is a NACK in the corresponding PUCCH resource to get more SL transmission grant from the base station, use a separate PUCCH resource to distinguish the CCA success or failure from that of an SL data decoding failure, and so forth.

By way of another example, in situations in which PSFCH is not received in the sidelink in time before the PUCCH resource is to transmit the SL HARQ feedback to the base station, the UE may transmit a DTX transmission in the PUCCH resource, transmit a NACK in the corresponding PUCCH resource however the UE may choose to ignore the new SL grant (received in response to the NACK) when the UE later receives ACK from PSFCH for the previous SL transmission, the UE may transmit a NACK in the corresponding PUCCH resource however the UE may retransmit in the received SL grant (received in response to the NACK) when the UE still has not received any SL HARQ feedback from PSFCH for the previous SL transmission, use a separate PUCCH resource to help distinguish the delay in the reception of PSFCH due to CCA failure from that of an SL data decoding failure, and so forth.

By utilizing the described techniques, the acquiring UE is able to provide feedback to the base station based on the status of the CCA that allows the base station to respond properly to the feedback and allows the acquiring UE to use the SL grant. For example, the UE is not limited to simply transmitting a NACK in all situations, which may alleviate the need for the base station to transmit a retransmission SL grant. The UE is able to proceed with sidelink communication using the SL grant despite some delays without resources being expended for a new SL grant. Additionally, the base station can distinguish between CCA (e.g., LBT) failures with respect to the HARQ failure and may provide resources accordingly.

Aspects of the present disclosure are described in the context of a wireless communications system. Aspects of the present disclosure are further illustrated and described with reference to device diagrams and flowcharts that relate to managing sidelink feedback to a base station.

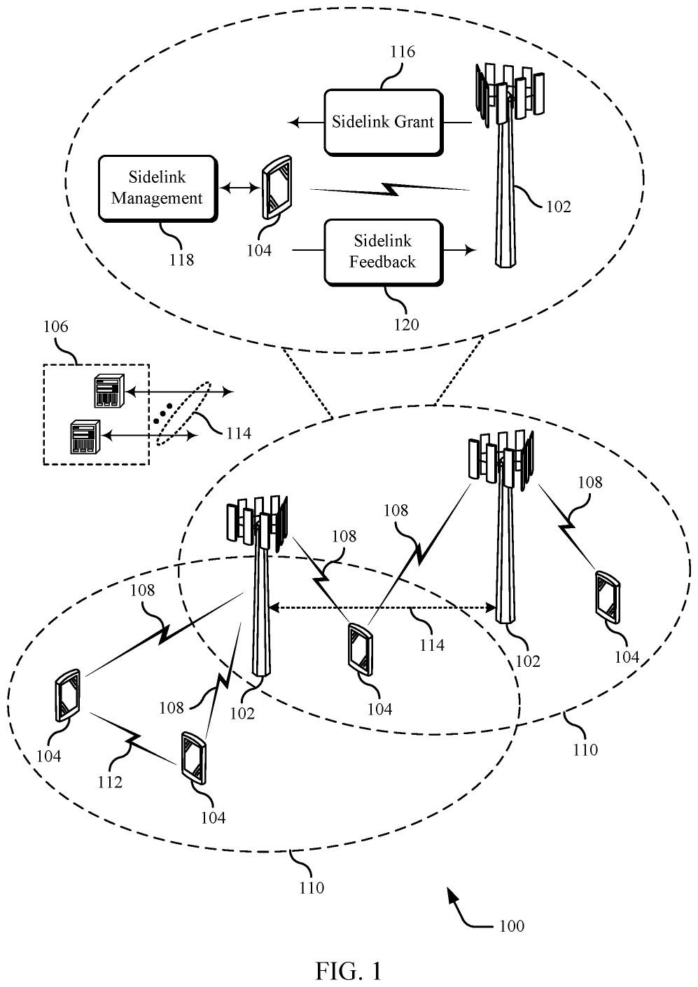

FIG. 1 illustrates an example of a wireless communications system 100 that supports managing sidelink feedback to a base station in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of managing sidelink feedback to a base station, as described herein. For instance, a base station 102 can communicate a SL grant 116 to the UE 104 that allows the UE 104 to use SL resources and time to communicate with other UEs 104 directly. In one or more implementations, the SL grant 116 includes various information such as a COT sharing indicator, one or more SL resources, a remaining CO duration, and so forth. The UE 104 receives the SL grant 116 and performs SL management 118 to manage SL communication with one or more other UEs 104 (e.g., via communication 112). The SL management 118 includes various operations, such as performing CCA, transmitting control information or data to another UE 104, receiving control information or data from another UE 104, sharing the SL grant 116 (e.g., a portion of the COT granted to the UE 104) with one or more other UEs 104, returning SL feedback 120 to the base station 102, and so forth.

The UE 104 communicates with the base station 102 using any of a variety of types of control signaling, such as at least one of radio resource control (RRC), downlink control information (DCI), uplink control information (UCI), medium access control (MAC) control element (CE), HARQ (e.g., SL HARQ), or the like. Similarly, the UE 104 communicates with other UEs 104 using any of a variety of types of control signaling, such as at least one of RRC, sidelink control information (SCI), MAC CE, HARQ (e.g., SL HARQ), or the like.

In aspects of managing sidelink feedback to a base station, channel access priority class (CAPC) is used. Table 1 includes example CAPC, where p refers to a CAPC, mₚ refers to a number of backoff stages for a given priority class p, CW_{min,p} refers to a minimum contention window for a given priority class p, CW_{max,p} refers to a maximum contention window for a given priority class p, T_{mcot,p} refers to a maximum channel occupancy time (MCOT) for a given priority class p (e.g., in milliseconds (ms)), and cwₚ refers to a contention window for a given priority class p.

TABLE 1
Channel Access Priority Class (CAPC)

| Channel | | | | | | |
|---|---|---|---|---|---|---|
| Access | | | | | | |
| Priority | | | | | | |
| Class (p) | mₚ | CW_{min, p} | CW_{max, p} | T_{mcot, p} | | allowed cwₚ sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

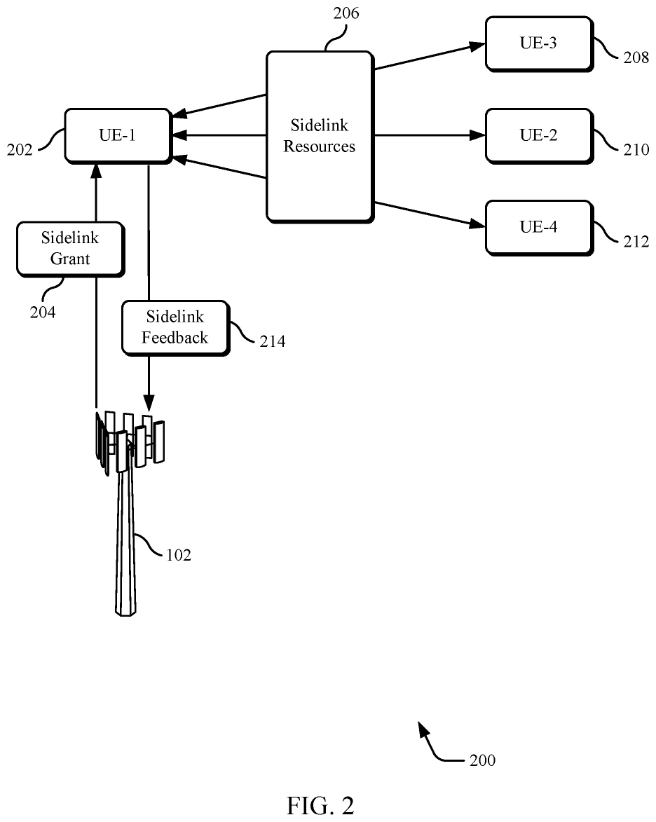

FIG. 2 illustrates a system 200 that supports managing sidelink feedback to a base station in accordance with aspects of the present disclosure. The system 200 may use the wireless communications system 100 and/or be implemented with the wireless communications system. The system 200 includes an initiating UE 202 (also referred to as an acquiring UE), which is a UE 104 of FIG. 1 that is referred to as an initiating UE because the UE 202 acquires and initiates SL communication with one or more other UEs, which are also referred to as secondary UEs. The initiating UE 202 acquires a COT (e.g., in an unlicensed spectrum) as part of a sidelink grant 204 (e.g., SL grant 116 of FIG. 1), such as from a base station 102.

The initiating UE 202 performs a CCA, such as LBT (e.g., Cat 2 LBT or Cat 4 LBT), on one or more sidelink resources 206 associated with the sidelink grant 204. CCA refers to checking whether the resource (e.g., a channel or frequency band) is clear or free, e.g., not in use by another device. CCA is performed using any of a variety of public or proprietary techniques, such as determining whether the amount of energy on the resource is below a threshold amount. The CCA for each of the one or more may be successful (the resource is clear or free) or a failure (the resource is not clear or not free).

The initiating UE 202, after performing CCA that is successful on at least one of the one or more sidelink resources 206, transmits control information or data to one or more of the secondary UEs 208, 210, or 212. The initiating UE 202 also receives control information or data from one or more of the secondary UEs 208, 210, or 212. The initiating UE 202 may also share the COT with one or more of the secondary UEs 208, 210, or 212, which may then use the shared portion of the COT to transmit control information or data to (and receive control information or data from) the UE 202 or another secondary UE 208, 210, or 212. Each secondary UE 208, 210, or 212, before transmitting control information or data on the one or more sidelink resources 206, performs CCA and does not proceed with the transmission until the CCA is successful.

The initiating UE 202 returns SL feedback 214 (e.g., SL feedback 120 of FIG. 1), which may be SL HARQ feedback, to the base station 102. The initiating UE 202 determines the appropriate SL feedback 214 based at least in part on a status of the CCA that was performed. The status of the CCA refers to whether the CCA was successful or a failure. The initiating UE 202 can provide various different SL HARQ feedback based at least in part on the CCA status as discussed in more detail below. This SL HARQ feedback can be based on at least in part the CCA status of one or more secondary UEs 208, 210, or 212. For example, a secondary UE 208, 210, or 212 may be delayed in transmitting a PSFCH due to CCA failure (or optionally other reasons) on the one or more sidelink resources 206.

In one or more implementations, the SL grant 116 (e.g., in a new DCI format) includes up to a maximum number of SL resources (e.g., less than or equal to 3, or a multi-slot SL resources including consecutive SL resources greater than 3), and the SL grant (e.g., DCI) may indicate at least one of the channel access priority class, the MCOT duration, the remaining channel occupancy duration, an LBT or other CCA type, a COT sharing indicator (e.g., an indication that the initiating UE 202 may share one or more of the SL resources associated with the SL grant 116 with one or more secondary UEs), one or more destination identifiers (IDs) for the SL (e.g., IDs of one or more secondary UEs with which the initiating UE 202 may share one or more of the SL resources associated with the SL grant 116), and so forth. The size of the SL grant may be in a new DCI format that is aligned with the existing DCI format 3_0 by using padding bits, and this new DCI format can be used to schedule SL transmission in the unlicensed spectrum.

The initiating UE 202, after successfully receiving the SL grant 116, may perform CCA, such as LBT according to the LBT type indicated in the DCI. Additionally or alternatively, the initiating UE 202 may use Cat 4 LBT for initiating the channel occupancy when there is no LBT type field in the DCI, and in the case of COT sharing for sidelink transmission initiated by the base station 102 (e.g., as indicated by the COT sharing indicator in the SL grant 116) the initiating UE 202 may use Cat 2 LBT.

The initiating UE 202 may perform Cat 4 LBT and initiate channel occupancy according to the channel access priority class value provided in the DCI. Additionally or alternatively, the initiating UE 202 may choose the channel access priority class value according to the priority or latency of the data selected according to the defined logical channel prioritization (LCP) rule and then initiate channel occupancy.

In one or more implementations, the initiating UE 202 may perform CCA (e.g., Cat 4 LBT) at the beginning of the first SL resource indicated in the DCI and when CCA fails the initiating UE 202 may perform CCA (e.g., Cat 4 LBT) at the beginning of the second SL resource indicated in the DCI and so on until CCA has been performed on all the SL resources associated with the SL grant 116 (e.g., as indicated in the DCI). When CCA (e.g., Cat 4 LBT) fails for all SL resources indicated in the DCI, the initiating UE 202 takes one or more actions.

In one or more implementations, when CCA (e.g., Cat 4 LBT) fails for all SL resources indicated in the DCI, the initiating UE 202 transmits an ACK in SL HARQ feedback in the corresponding PUCCH resource. The initiating UE 202 also switches to autonomous resource allocation mode to select another SL resource (other than the SL resources indicated in the DCI) for any further transmission. In the autonomous resource allocation mode, the initiating UE 202 selects the SL resources on its own based on some sensing or on some pre configuration of the initiating UE 202.

Additionally or alternatively, when CCA (e.g., Cat 4 LBT) fails for all SL resources indicated in DCI, the initiating UE 202 transmits a NACK in SL HARQ feedback in the corresponding PUCCH resource to get another SL transmission grant from the base station 102.

Additionally or alternatively, when CCA (e.g., Cat 4 LBT) fails for all SL resources indicated in the DCI and switching from base station scheduled SL transmission (e.g., mode 1) to autonomous resource selection (e.g., mode 2) is disabled in the corresponding SL resource pool, the initiating UE 202 transmits a NACK in SL HARQ feedback in the corresponding PUCCH resource to get another SL transmission grant from the base station 102.

Additionally or alternatively, when CCA (e.g., Cat 4 LBT) fails for all SL resources indicated in the DCI, the initiating UE 202 uses a separate PUCCH resource to distinguish the CCA success/failure feedback from that of the decoding failures of SL data feedback, which can be implemented by using a new field in the DCI. The new field in the DCI may provide a separate PUCCH resource to determine CCA status for the SL resources indicated in the DCI. The new PUCCH resource to report CCA status may be provided irrespective of the PUCCH resource for reporting SL HARQ feedback to the base station 102, and this new PUCCH resource may also be provided in a resource pool with PSFCH feedback disabled.

For example, when the initiating UE 202 encounters CCA failures when trying to transmit in the indicated SL resources, the initiating UE 202 may report CCA failure ‘0’ in the corresponding new feedback resource to the base station 102, which may help the base station 102 distinguish transmission/decoding failures of SL data from that of the CCA success/failures. Traditionally the base station 102, after receiving the SL HARQ feedback report, if it is NACK then the base station 102 provides a retransmission grant and if it is ACK then the base station 102 provides a new SL grant based on the previously transmitted buffer status report (BSR). With the introduction of this new feedback type for CCA (e.g., LBT) failures, the base station 102, after receiving the CCA (e.g., LBT) failure indication, may provide an SL grant for the same HARQ process and same transport block (TB) size which is similar to the previous SL grant.

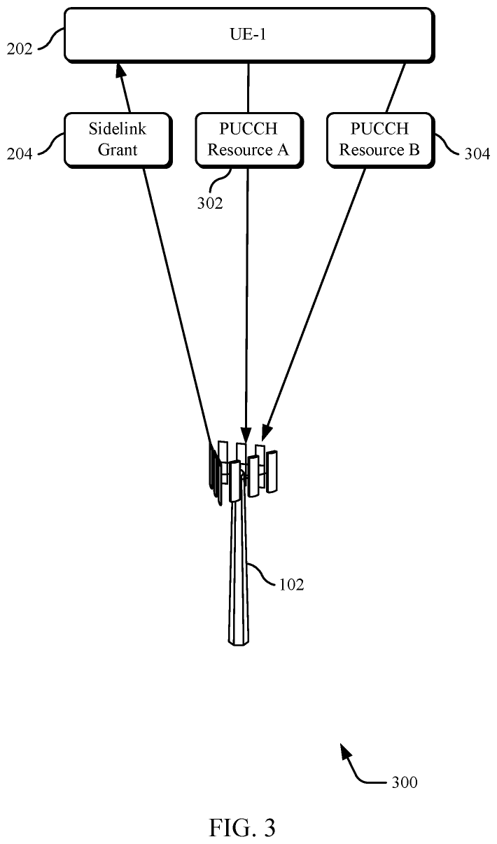

FIG. 3 illustrates an example 300 of using a separate PUCCH resource. In the example 300, the initiating UE 202 receives a sidelink grant 204 from the base station 102. When CCA (e.g., Cat 4 LBT) fails for all SL resources indicated in the DCI, the initiating UE 202 reports a particular value (e.g., “0”) in a PUCCH resource A 302 to indicate the CCA failure and a particular value (e.g., “1”) in a PUCCH resource B 304 to indicate there was no decoding failure. When there is a decoding failure of SL data feedback, the initiating UE 202 reports a particular value (e.g., “0”) in PUCCH resource B 304 to indicate a decoding failure and a particular value (e.g., “1”) in the PUCCH resource A 302 to indicate there was no CCA failure.

Returning to FIG. 2, in one or more implementations, when the initiating UE 202 receives a COT sharing indicator from the base station 102 for the base station 102 initiated channel occupancy, and the indicated SL resources in the DCI received together with the COT sharing indicator is within the remaining channel occupancy duration. Accordingly, the initiating UE 202 may perform Cat 2 LBT prior transmitting in those SL resources.

Additionally or alternatively, when the initiating UE 202 receives a COT sharing indicator from the base station 102 for the base station 102 initiated channel occupancy, and the indicated SL resources in the DCI received together with the COT sharing indicator is outside the channel occupancy duration, then the initiating UE 202 switches to autonomous resource selection (e.g., mode 2) to select SL resources within the remaining channel occupancy duration indicated in the DCI. The initiating UE 202 performs Cat 4 LBT and initiates a new COT before SL transmission in the SL resources selected via autonomous resource selection.

Additionally or alternatively, when the initiating UE 202 receives a COT sharing indicator from the base station 102 for the base station 102 initiated channel occupancy, and there no SL resources signaled with the received COT sharing indicator then the initiating UE 202 switches to autonomous resource selection (e.g., mode 2) to select resources within the remaining channel occupancy duration.

Additionally or alternatively, when the initiating UE 202 receives a COT sharing indicator from the base station 102 for the base station 102 initiated channel occupancy, and the indicated SL resources in the DCI received together with the COT sharing indicator are outside the channel occupancy duration, then the initiating UE 202 ignores the SL grant in the DCI and transmits an ACK in SL HARQ feedback in the corresponding PUCCH resource. The initiating UE 202 switches to autonomous resource selection (e.g., mode 2) to select resources within the remaining channel occupancy duration.

Additionally or alternatively, when the initiating UE 202 receives a COT sharing indicator from the base station 102 for the base station 102 initiated channel occupancy, and the initiating UE 202 is configured with configured grant (CG) resources, when the initiating UE 202 receives the COT sharing indicator the initiating UE 202 may implicitly activate start making transmission in the CG resource. The CG resource may be preconfigured in the initiating UE 202 (e.g., stored locally) or received by the initiating UE 202 (e.g., from the base station 102) prior to receipt of the SL grant.

In one or more implementations, a PSFCH is not received in the sidelink in time before the PUCCH resource is to transmit the SL HARQ feedback to the base station 102 (e.g., is not received before the PUCCH resource is to transmit the SL HARQ feedback or before a PUCCH preparation time for reporting the SL HARQ feedback to the base station 102). In such situations, the initiating UE 202 may perform a DTX transmission (e.g., indicating the initiating UE 202 is going into a DTX mode or reducing transmissions) in the corresponding PUCCH resource (e.g., include a DTX indication in the SL HARQ feedback).

Additionally or alternatively, if a PSFCH is not received in the sidelink in time before the PUCCH resource is to transmit the SL HARQ feedback to the base station 102, the initiating UE 202 transmits a NACK in the SL HARQ feedback of the corresponding PUCCH resource. The initiating UE 202 may choose to ignore the corresponding SL grant (received in response to the NACK) when the initiating UE 202 later receives ACK from PSFCH for the previous SL transmission.

Additionally or alternatively, if a PSFCH is not received in the sidelink in time before the PUCCH resource is to transmit the SL HARQ feedback to the base station 102, the initiating UE 202 may transmit a NACK in the SL HARQ feedback of the corresponding PUCCH resource. The initiating UE 202 may choose to perform a new transmission for the corresponding SL grant when the initiating UE 202 later receives an ACK from PSFCH for the previous SL transmission.

Additionally or alternatively, if a PSFCH is not received in the sidelink in time before the PUCCH resource is to transmit the SL HARQ feedback to the base station 102, the initiating UE 202 transmit a NACK in the SL HARQ feedback of the corresponding PUCCH resource. The initiating UE 202 may retransmit in the received SL grant (received in response to the NACK) when the initiating UE 202 still has not received any SL HARQ feedback from PSFCH for the previous SL transmission.

Additionally or alternatively, if a PSFCH is not received in the sidelink in time before the PUCCH resource is to transmit the SL HARQ feedback to the base station 102, the initiating UE 202 uses a separate PUCCH resource to help distinguish the delay in the reception of PSFCH due to LBT failure from that of the SL data decoding failure, which can be implemented by using a new field in the DCI. A new indicator may be transmitted in the PUCCH resource to the base station 102 indicating delay in the reception of PSFCH due to LBT failure. The base station 102 may not schedule retransmission grant until the base station 102 receives the corresponding SL HARQ feedback or may request or trigger a one shot SL HARQ feedback report from the initiating UE 202.

In one or more implementations, a non-numerical SL HARQ feedback indicator is transmitted (e.g., in a new DCI format) by using one of the code points configured in the PSFCH to SL HARQ feedback timing indicator. In such implementations, a corresponding PUCCH resource may not be provided in the DCI and hence the SL HARQ feedback reporting can be postponed until a separate trigger is received.

The initiating UE 202 can enable non-numerical SL HARQ feedback in the SCI for the corresponding SL grant (e.g., the SL grant received with the non-numerical SL HARQ feedback indicator).

The base station 102 can transmit such a trigger to request SL HARQ feedback for SL HARQ processes previously indicated with non-numerical SL HARQ feedback by, for example, transmitting a next DCI scheduling PSSCH transmission with numerical PSFCH to SL HARQ feedback timing indicator which implies request for the transmission of SL HARQ feedback for SL HARQ processes (e.g., a subset of SL HARQ processes) previously signalled with a non-numerical SL HARQ feedback indicator. The SL HARQ feedback report can be multiplexed in the PUSCH or PUCCH resource, which can be provided by the base station 102 for transmitting SL HARQ feedback report.

Additionally or alternatively, when the initiating UE 202 autonomously decides on the non-numerical SL HARQ feedback request transmission irrespective of the PSFCH to SL HARQ feedback timing indicator, then the initiating UE 202 may transmit a DTX transmission in the corresponding PUCCH resource. Additionally or alternatively, the initiating UE 202 may transmit other data or control information as discussed above. For example, the initiating UE 202 may transmit an ACK in SL HARQ feedback in the corresponding PUCCH resource. By way of another example, the initiating UE 202 transmits a NACK in SL HARQ feedback in the corresponding PUCCH resource to get another SL transmission grant from the base station 102. By way of another example, the initiating UE 202 uses a separate PUCCH resource to distinguish the CCA success/failure feedback from that of the decoding failures of SL data feedback, which can be implemented by using a new field in the DCI. The new field in the DCI may provide a separate PUCCH resource to determine CCA status for the SL resources indicated in the DCI. The new PUCCH resource to report CCA status may be provided irrespective of the PUCCH resource for reporting SL HARQ feedback to the base station 102, and this new PUCCH resource may also be provided in a resource pool with PSFCH feedback disabled.

In one or more implementations, the base station 102 may initiate a new COT after successfully performing CCA (e.g., Cat 4 LBT) and may transmit in the first DCI to indicate the intention for COT sharing to the initiating UE 202 or destination IDs using a unicast DCI or a group common DCI format for scheduling sidelink. The actual trigger containing a starting slot for COT sharing and the remaining CO duration may be indicated by a follow-up using a second DCI. In this situation, the remaining CO duration may be calculated from the slot where the initiating UE 202 detects the second SCI. The remaining CO duration may be calculated, for example, from the reception time slot of the second DCI.

Additionally or alternatively, the base station 102 may initiate a new COT after successfully performing CCA (e.g., Cat 4 LBT) and may transmit a COT sharing indicator in the DCI. The DCI includes a time gap value (e.g., 3 bits) determined by a higher layer parameter (e.g., sl-DCI-ToSL-Trans) can indicate the starting of CO duration for the SL data transmission.

In one or more implementations, the initiating UE 202 may need preparation time or processing time to perform autonomous resource selection (e.g., mode 2) to select SL resources after receiving a COT sharing indicator from the base station 102 (e.g., when no SL resources are signaled with the received COT sharing indicator). The preparation time or processing time can be achieved with the above option of using a time gap field in DCI and/or using two DCIs to indicate COT sharing.

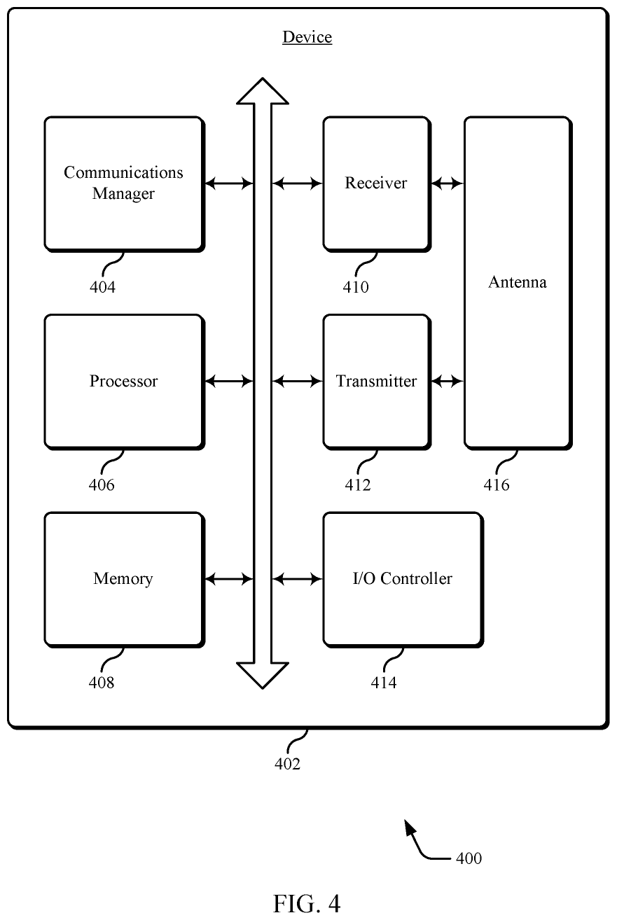

FIG. 4 illustrates an example of a block diagram 400 of a device 402 that supports managing sidelink feedback to a base station in accordance with aspects of the present disclosure. The device 402 may be an example of a UE 104 as described herein. The device 402 may support wireless communication and/or network signaling with one or more base stations 102, other UEs 104, network entities and devices, or any combination thereof. The device 402 may include components for bi-directional communications including components for transmitting and receiving communications, such as a communications manager 404, a processor 406, a memory 408, a receiver 410, a transmitter 412, and an I/O controller 414. These components may be in electronic communication or otherwise coupled (e.g., operatively, communicatively, functionally, electronically, electrically) via one or more interfaces (e.g., buses).

The communications manager 404, the receiver 410, the transmitter 412, or various combinations thereof or various components thereof may be examples of means for performing various aspects of the present disclosure as described herein. For example, the communications manager 404, the receiver 410, the transmitter 412, or various combinations or components thereof may support a method for performing one or more of the functions described herein.

In some implementations, the communications manager 404, the receiver 410, the transmitter 412, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 406 and the memory 408 coupled with the processor 406 may be configured to perform one or more of the functions described herein (e.g., by executing, by the processor 406, instructions stored in the memory 408).

Additionally or alternatively, in some implementations, the communications manager 404, the receiver 410, the transmitter 412, or various combinations or components thereof may be implemented in code (e.g., as communications management software or firmware) executed by the processor 406. If implemented in code executed by the processor 406, the functions of the communications manager 404, the receiver 410, the transmitter 412, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 404 may be configured to perform various operations (e.g., receiving, monitoring, transmitting) using or otherwise in cooperation with the receiver 410, the transmitter 412, or both. For example, the communications manager 404 may receive information from the receiver 410, send information to the transmitter 412, or be integrated in combination with the receiver 410, the transmitter 412, or both to receive information, transmit information, or perform various other operations as described herein. Although the communications manager 404 is illustrated as a separate component, in some implementations, one or more functions described with reference to the communications manager 404 may be supported by or performed by the processor 406, the memory 408, or any combination thereof. For example, the memory 408 may store code, which may include instructions executable by the processor 406 to cause the device 402 to perform various aspects of the present disclosure as described herein, or the processor 406 and the memory 408 may be otherwise configured to perform or support such operations.

For example, the communications manager 404 may support wireless communication and/or network signaling at a device (e.g., the device 402, a UE) in accordance with examples as disclosed herein. The communications manager 404 and/or other device components may be configured as or otherwise support an apparatus, such as a UE, including a transceiver; a processor coupled to the transceiver, the processor and the transceiver configured to cause the apparatus to: receive, from a base station, first control signaling indicating a first SL grant having one or more associated SL resources; perform CCA for the one or more associated SL resources; and transmit, to the base station, second control signaling based at least in part on a status of the CCA.

Additionally, the apparatus (e.g., a UE) includes any one or combination of: where the processor and the transceiver are further configured to cause the apparatus to perform, in response to the one or more SL resources not being included in the first SL grant or the one or more SL resources being outside a remaining CO determination, autonomous resource selection to obtain a resource for the first SL grant; where the second control signaling comprises a SL HARQ feedback, and where the processor and the transceiver are further configured to cause the apparatus to transmit, in response to a PSFCH not being received from a second apparatus via the one or more SL resources before a PUCCH resource is to transmit the SL HARQ feedback to the base station, a DTX in the SL HARQ feedback; where the second control signaling comprises a SL HARQ feedback, and where the processor and the transceiver are further configured to cause, in response to a PSFCH not being received from a second apparatus via the one or more SL resources before a PUCCH resource is to transmit the SL HARQ feedback to the base station, the apparatus to: transmit a NACK in the SL HARQ feedback; receive, from the base station, a third control signaling indicating a second SL grant; and ignore, in response to the PSFCH being received from the second apparatus via the one or more SL resources after the SL HARQ feedback is transmitted to the base station, the second SL grant; where the second control signaling comprises a first SL HARQ feedback in a first PUCCH resource indicating a first status of the CCA if the CCA failed for the one or more SL resources, or a second SL HARQ feedback in a second PUCCH resource indicating a second status of the CCA if a decoding failure of SL data occurred; where the first SL grant identifies one or more of the associated SL resources, a COT sharing indicator, or a remaining CO duration; where the second control signaling includes a SL HARQ feedback; where the second control signaling comprises a SL HARQ feedback, and where the processor and the transceiver are further configured to cause the apparatus, in response to the CCA failing for the one or more SL resources, to: include an ACK in the SL HARQ feedback; and perform autonomous resource selection to obtain a resource for the first SL grant; where the second control signaling comprises a SL HARQ feedback, and where the processor and the transceiver are further configured to cause the apparatus, in response to the CCA failing for the one or more SL resources, to: include a NACK in the SL HARQ feedback; and receive, from the base station in response to the SL HARQ feedback, a second SL grant; where the processor and the transceiver are further configured to cause the apparatus, in response to the first SL grant identifying a COT sharing indicator and the one or more associated SL resources, to perform Cat 2 LBT as the CCA; where the processor and the transceiver are further configured to cause the apparatus, in response to the first SL grant not identifying the one or more associated SL resources, to perform autonomous resource selection to obtain a resource for the first SL grant within a remaining CO duration; where the second control signaling comprises a SL HARQ feedback, and where the processor and the transceiver are further configured to cause, in response to a PSFCH not being received from a second apparatus via the one or more SL resources before a PUCCH resource is to transmit the SL HARQ feedback to the base station, the apparatus to: transmit a NACK in the SL HARQ feedback; receive, from the base station, a third control signaling indicating a second SL grant; and transmit a new transmission, in response to the PSFCH not being received from the second apparatus via the one or more SL resources, to the second apparatus via one or more SL resources associated with the second SL grant; where the second control signaling comprises a SL HARQ feedback, and where the processor and the transceiver are further configured to cause, in response to a PSFCH not being received from a second apparatus via the one or more SL resources before a first PUCCH resource is to transmit the SL HARQ feedback to the base station, the apparatus to transmit, in a second PUCCH resource, the SL HARQ feedback indicating a delay in reception of the PSFCH; where the processor and the transceiver are further configured to cause the apparatus to: receive, from the base station, a non-numerical SL HARQ feedback indicator; receive, from the base station after receiving the non-numerical SL HARQ feedback indicator, a trigger to request the SL HARQ feedback; and transmit, to the base station in response to the trigger, the second control signaling; where the processor and the transceiver are further configured to cause the apparatus to: receive, from the base station as part of the first control signaling, an indication of a starting of a CO duration for transmission on the one or more associated SL resources; and perform, during a time gap indicated by the starting of the CO duration, autonomous resource selection to obtain a resource for the first SL grant.

The communications manager 404 and/or other device components may be configured as or otherwise support a means for wireless communication and/or network signaling at a UE, including receiving, from a base station, first control signaling indicating a first SL grant having one or more associated SL resources; performing a CCA for the one or more associated SL resources; and transmitting, to the base station, second control signaling based at least in part on a status of the CCA.

Additionally, wireless communication and/or network signaling at the UE includes any one or combination of: performing, in response to the one or more SL resources not being included in the first SL grant or the one or more SL resources being outside a remaining CO determination, autonomous resource selection to obtain a resource for the first SL grant; where the second control signaling comprises a SL HARQ feedback, and transmitting, in response to a PSFCH not being received from a second apparatus via the one or more SL resources before a PUCCH resource is to transmit the SL HARQ feedback to the base station, a DTX in the SL HARQ feedback; where the second control signaling comprises a SL HARQ feedback, and, in response to a PSFCH not being received from a second apparatus via the one or more SL resources before a PUCCH resource is to transmit the SL HARQ feedback to the base station: transmitting a NACK in the SL HARQ feedback; receiving, from the base station, a third control signaling indicating a second SL grant; and ignoring, in response to the PSFCH being received from the second apparatus via the one or more SL resources after the SL HARQ feedback is transmitted to the base station, the second SL grant; where the second control signaling comprises a first SL HARQ feedback in a first PUCCH resource indicating a first status of the CCA if the CCA failed for the one or more SL resources, or a second SL HARQ feedback in a second PUCCH resource indicating a second status of the CCA if a decoding failure of SL data occurred; where the first SL grant identifies one or more of the associated SL resources, a COT sharing indicator, or a remaining CO duration; where the second control signaling includes a SL HARQ feedback; where the second control signaling comprises a SL HARQ feedback, and, in response to the CCA failing for the one or more SL resources: including an ACK in the SL HARQ feedback; and performing autonomous resource selection to obtain a resource for the first SL grant; where the second control signaling comprises a SL HARQ feedback, and, in response to the CCA failing for the one or more SL resources: include a NACK in the SL HARQ feedback; and receive, from the base station in response to the SL HARQ feedback, a second SL grant; in response to the first SL grant identifying a COT sharing indicator and the one or more associated SL resources, performing Cat 2 LBT as the CCA; in response to the first SL grant not identifying the one or more associated SL resources, performing autonomous resource selection to obtain a resource for the first SL grant within a remaining CO duration; where the second control signaling comprises a SL HARQ feedback, and, in response to a PSFCH not being received from a second apparatus via the one or more SL resources before a PUCCH resource is to transmit the SL HARQ feedback to the base station: transmitting a NACK in the SL HARQ feedback; receiving, from the base station, a third control signaling indicating a second SL grant; and transmitting a new transmission, in response to the PSFCH not being received from the second apparatus via the one or more SL resources, to the second apparatus via one or more SL resources associated with the second SL grant; where the second control signaling comprises a SL HARQ feedback, and, in response to a PSFCH not being received from a second apparatus via the one or more SL resources before a first PUCCH resource is to transmit the SL HARQ feedback to the base station, transmitting the SL HARQ feedback indicating a delay in reception of the PSFCH in a second PUCCH resource; receiving, from the base station, a non-numerical SL HARQ feedback indicator; receiving, from the base station after receiving the non-numerical SL HARQ feedback indicator, a trigger to request the SL HARQ feedback; and transmitting, to the base station in response to the trigger, the second control signaling; receiving, from the base station as part of the first control signaling, an indication of a starting of a CO duration for transmission on the one or more associated SL resources; and performing, during a time gap indicated by the starting of the CO duration, autonomous resource selection to obtain a resource for the first SL grant.

The processor 406 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 406 may be configured to operate a memory array using a memory controller. In some other implementations, a memory controller may be integrated into the processor 406. The processor 406 may be configured to execute computer-readable instructions stored in a memory (e.g., the memory 408) to cause the device 402 to perform various functions of the present disclosure.

The memory 408 may include random access memory (RAM) and read-only memory (ROM). The memory 408 may store computer-readable, computer-executable code including instructions that, when executed by the processor 406 cause the device 402 to perform various functions described herein. The code may be stored in a non-transitory computer-readable medium such as system memory or another type of memory. In some implementations, the code may not be directly executable by the processor 406 but may cause a computer (e.g., when compiled and executed) to perform functions described herein. In some implementations, the memory 408 may include, among other things, a basic I/O system (BIOS) which may control basic hardware or software operation such as the interaction with peripheral components or devices.

The I/O controller 414 may manage input and output signals for the device 402. The I/O controller 414 may also manage peripherals not integrated into the device 402. In some implementations, the I/O controller 414 may represent a physical connection or port to an external peripheral. In some implementations, the I/O controller 414 may utilize an operating system such as iOS®, ANDROID®, MS-DOS®, MS-WINDOWS®, OS/2®, UNIX®, LINUX®, or another known operating system. In some implementations, the I/O controller 414 may be implemented as part of a processor, such as the processor 406. In some implementations, a user may interact with the device 402 via the I/O controller 414 or via hardware components controlled by the I/O controller 414.

In some implementations, the device 402 may include a single antenna 416. However, in some other implementations, the device 402 may have more than one antenna 416, which may be capable of concurrently transmitting or receiving multiple wireless transmissions. The receiver 410 and the transmitter 412 may communicate bi-directionally, via the one or more antennas 416, wired, or wireless links as described herein. For example, the receiver 410 and the transmitter 412 may represent a wireless transceiver and may communicate bi-directionally with another wireless transceiver. The transceiver may also include a modem to modulate the packets, to provide the modulated packets to one or more antennas 416 for transmission, and to demodulate packets received from the one or more antennas 416.

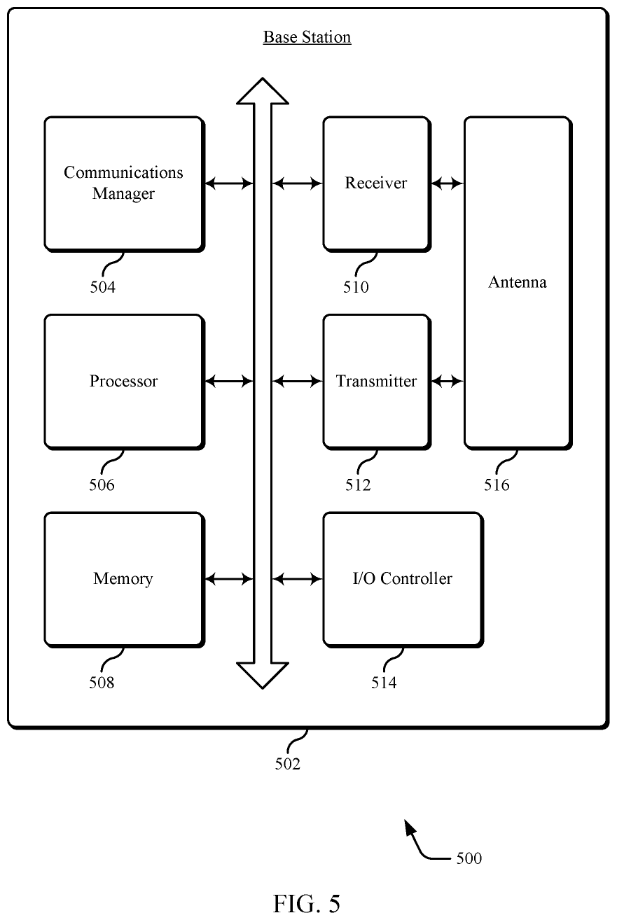

FIG. 5 illustrates an example of a block diagram 500 of a device 502 that supports managing sidelink feedback to a base station in accordance with aspects of the present disclosure. The device 502 may be an example of a base station 102, such as a gNB as described herein. The device 502 may support wireless communication and/or network signaling with one or more base stations 102, other UEs 104, core network devices and functions (e.g., core network 106), or any combination thereof. The device 502 may include components for bi-directional communications including components for transmitting and receiving communications, such as a communications manager 504, a processor 506, a memory 508, a receiver 510, a transmitter 512, and an I/O controller 514. These components may be in electronic communication or otherwise coupled (e.g., operatively, communicatively, functionally, electronically, electrically) via one or more interfaces (e.g., buses).

The communications manager 504, the receiver 510, the transmitter 512, or various combinations thereof or various components thereof may be examples of means for performing various aspects of the present disclosure as described herein. For example, the communications manager 504, the receiver 510, the transmitter 512, or various combinations or components thereof may support a method for performing one or more of the functions described herein.

In some implementations, the communications manager 504, the receiver 510, the transmitter 512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 506 and the memory 508 coupled with the processor 506 may be configured to perform one or more of the functions described herein (e.g., by executing, by the processor 506, instructions stored in the memory 508).

Additionally or alternatively, in some implementations, the communications manager 504, the receiver 510, the transmitter 512, or various combinations or components thereof may be implemented in code (e.g., as communications management software or firmware) executed by the processor 506. If implemented in code executed by the processor 506, the functions of the communications manager 504, the receiver 510, the transmitter 512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 504 may be configured to perform various operations (e.g., receiving, monitoring, transmitting) using or otherwise in cooperation with the receiver 510, the transmitter 512, or both. For example, the communications manager 504 may receive information from the receiver 510, send information to the transmitter 512, or be integrated in combination with the receiver 510, the transmitter 512, or both to receive information, transmit information, or perform various other operations as described herein. Although the communications manager 504 is illustrated as a separate component, in some implementations, one or more functions described with reference to the communications manager 504 may be supported by or performed by the processor 506, the memory 508, or any combination thereof. For example, the memory 508 may store code, which may include instructions executable by the processor 506 to cause the device 502 to perform various aspects of the present disclosure as described herein, or the processor 506 and the memory 508 may be otherwise configured to perform or support such operations.

For example, the communications manager 504 may support wireless communication and/or network signaling at a device (e.g., the device 502, a base station) in accordance with examples as disclosed herein. The communications manager 504 and/or other device components may be configured as or otherwise support an apparatus, such as a base station, including a transceiver; a processor coupled to the transceiver, the processor and the transceiver configured to cause the apparatus to: transmit, to a UE, first control signaling indicating a first SL grant having one or more associated SL resources; and receive, from the UE, second control signaling based at least in part on a status of CCA performed by the UE for the one or more associated SL resources.

Additionally, the apparatus (e.g., a base station) includes any one or combination of: where the second control signaling comprises a first SL HARQ feedback in a first PUCCH resource indicating a first status of the CCA if the CCA failed for the one or more SL resources, or a second SL HARQ feedback in a second PUCCH resource indicating a second status of the CCA if a decoding failure of SL data occurred; where the processor and the transceiver are further configured to cause the apparatus to: transmit, to the UE, a non-numerical SL HARQ feedback indicator; transmit, to the UE after transmitting the non-numerical SL HARQ feedback indicator, a trigger to request the SL HARQ feedback; and receive, from the UE in response to the trigger, the second control signaling.

The communications manager 504 and/or other device components may be configured as or otherwise support a means for wireless communication and/or network signaling at a base station, including transmitting, to a UE, first control signaling indicating a first SL grant having one or more associated SL resources; and receiving, from the UE, second control signaling based at least in part on a status of CCA performed by the UE for the one or more associated SL resources.

Additionally, wireless communication at the base station includes any one or combination of: where the second control signaling comprises a first SL HARQ feedback in a first PUCCH resource indicating a first status of the CCA if the CCA failed for the one or more SL resources, or a second SL HARQ feedback in a second PUCCH resource indicating a second status of the CCA if a decoding failure of SL data occurred; transmitting, to the UE, a non-numerical SL HARQ feedback indicator; transmitting, to the UE after transmitting the non-numerical SL HARQ feedback indicator, a trigger to request the SL HARQ feedback; and receiving, from the UE in response to the trigger, the second control signaling.

The processor 506 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 506 may be configured to operate a memory array using a memory controller. In some other implementations, a memory controller may be integrated into the processor 506. The processor 506 may be configured to execute computer-readable instructions stored in a memory (e.g., the memory 508) to cause the device 502 to perform various functions of the present disclosure.

The memory 508 may include random access memory (RAM) and read-only memory (ROM). The memory 508 may store computer-readable, computer-executable code including instructions that, when executed by the processor 506 cause the device 502 to perform various functions described herein. The code may be stored in a non-transitory computer-readable medium such as system memory or another type of memory. In some implementations, the code may not be directly executable by the processor 506 but may cause a computer (e.g., when compiled and executed) to perform functions described herein. In some implementations, the memory 508 may include, among other things, a basic I/O system (BIOS) which may control basic hardware or software operation such as the interaction with peripheral components or devices.

The I/O controller 514 may manage input and output signals for the device 502. The I/O controller 514 may also manage peripherals not integrated into the device 502. In some implementations, the I/O controller 514 may represent a physical connection or port to an external peripheral. In some implementations, the I/O controller 514 may utilize an operating system such as iOS®, ANDROID®, MS-DOS®, MS-WINDOWS®, OS/2®, UNIX®, LINUX®, or another known operating system. In some implementations, the I/O controller 514 may be implemented as part of a processor, such as the processor 506. In some implementations, a user may interact with the device 502 via the I/O controller 514 or via hardware components controlled by the I/O controller 514.

In some implementations, the device 502 may include a single antenna 516. However, in some other implementations, the device 502 may have more than one antenna 516, which may be capable of concurrently transmitting or receiving multiple wireless transmissions. The receiver 510 and the transmitter 512 may communicate bi-directionally, via the one or more antennas 516, wired, or wireless links as described herein. For example, the receiver 510 and the transmitter 512 may represent a wireless transceiver and may communicate bi-directionally with another wireless transceiver. The transceiver may also include a modem to modulate the packets, to provide the modulated packets to one or more antennas 516 for transmission, and to demodulate packets received from the one or more antennas 516.

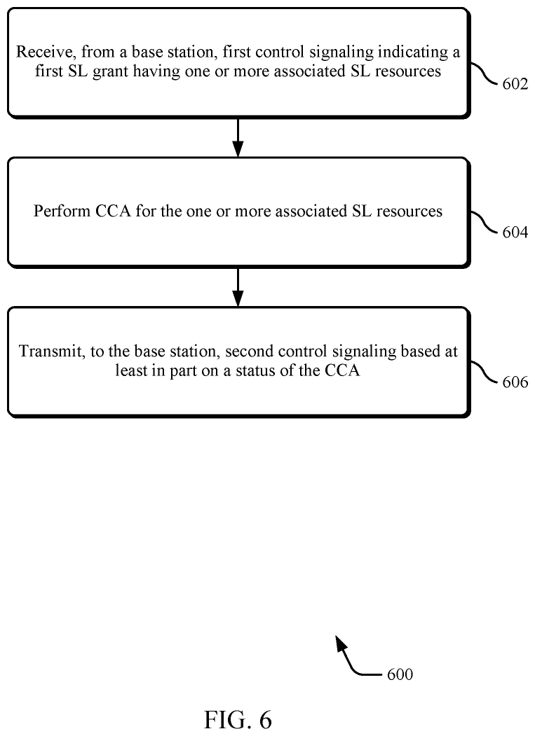

FIG. 6 illustrates a flowchart of a method 600 that supports managing sidelink feedback to a base station in accordance with aspects of the present disclosure. The operations of the method 600 may be implemented and performed by a device or its components, such as a UE 104 or UE 202 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 602, the method may include receiving, from a base station, first control signaling indicating a first SL grant having one or more associated SL resources. The operations of 602 may be performed in accordance with examples as described herein. In some implementations, aspects of the operations of 602 may be performed by a device as described with reference to FIG. 1 or FIG. 2.

At 604, the method may include performing CCA for the one or more associated SL resources. The operations of 604 may be performed in accordance with examples as described herein. In some implementations, aspects of the operations of 604 may be performed by a device as described with reference to FIG. 1 or FIG. 2.

At 606, the method may include transmitting, to the base station, second control signaling based at least in part on a status of the CCA. The operations of 606 may be performed in accordance with examples as described herein. In some implementations, aspects of the operations of 606 may be performed by a device as described with reference to FIG. 1 or FIG. 2.

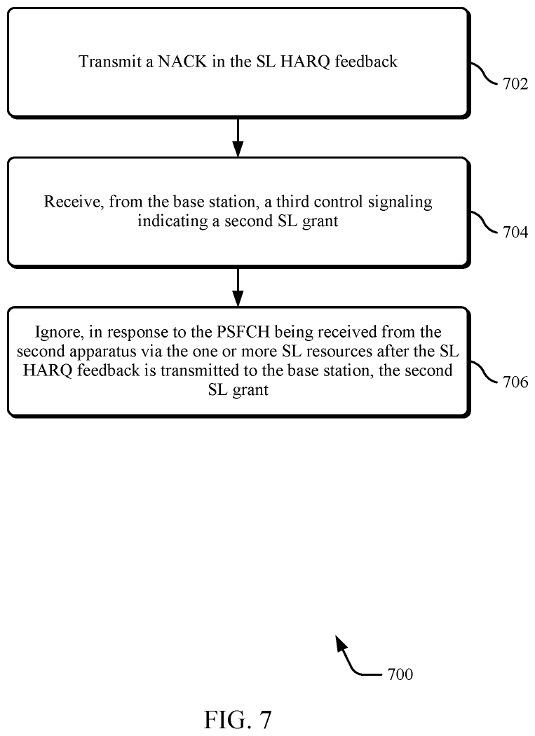

FIG. 7 illustrates a flowchart of a method 700 that supports managing sidelink feedback to a base station in accordance with aspects of the present disclosure. The operations of the method 700 may be implemented and performed by a device or its components, such as a UE 104 or UE 202 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 702, the method may include transmitting a NACK in the SL HARQ feedback. The operations of 702 may be performed in accordance with examples as described herein. In some implementations, aspects of the operations of 702 may be performed by a device as described with reference to FIG. 1 or FIG. 2.

At 704, the method may include receiving, from the base station, a third control signaling indicating a second SL grant. The operations of 704 may be performed in accordance with examples as described herein. In some implementations, aspects of the operations of 704 may be performed by a device as described with reference to FIG. 1 or FIG. 2.

At 706, the method may include ignoring, in response to the PSFCH being received from the second apparatus via the one or more SL resources after the SL HARQ feedback is transmitted to the base station, the second SL grant. The operations of 706 may be performed in accordance with examples as described herein. In some implementations, aspects of the operations of 706 may be performed by a device as described with reference to FIG. 1 or FIG. 2.

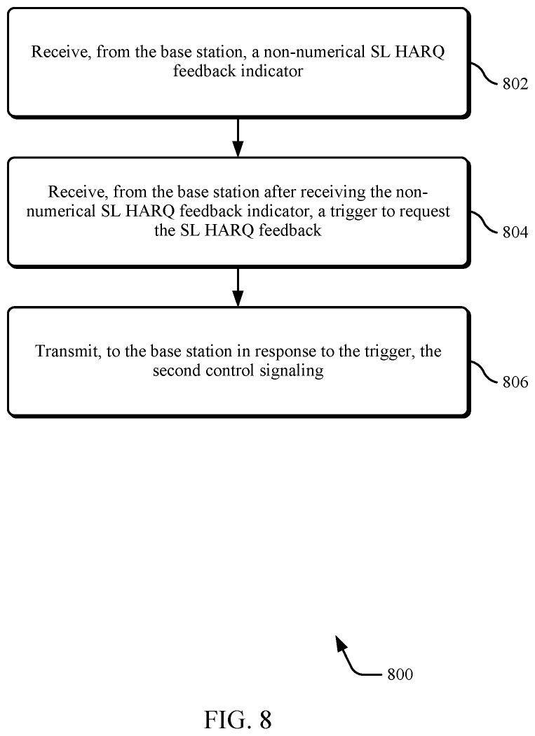

FIG. 8 illustrates a flowchart of a method 800 that supports managing sidelink feedback to a base station in accordance with aspects of the present disclosure. The operations of the method 800 may be implemented and performed by a device or its components, such as a UE 104 or UE 202 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 802, the method may include receiving, from the base station, a non-numerical SL HARQ feedback indicator. The operations of 802 may be performed in accordance with examples as described herein. In some implementations, aspects of the operations of 802 may be performed by a device as described with reference to FIG. 1 or FIG. 2.

At 804, the method may include receiving, from the base station after receiving the non-numerical SL HARQ feedback indicator, a trigger to request the SL HARQ feedback. The operations of 804 may be performed in accordance with examples as described herein. In some implementations, aspects of the operations of 804 may be performed by a device as described with reference to FIG. 1 or FIG. 2.

At 806, the method may include transmitting, to the base station in response to the trigger, the second control signaling. The operations of 806 may be performed in accordance with examples as described herein. In some implementations, aspects of the operations of 806 may be performed by a device as described with reference to FIG. 1 or FIG. 2.

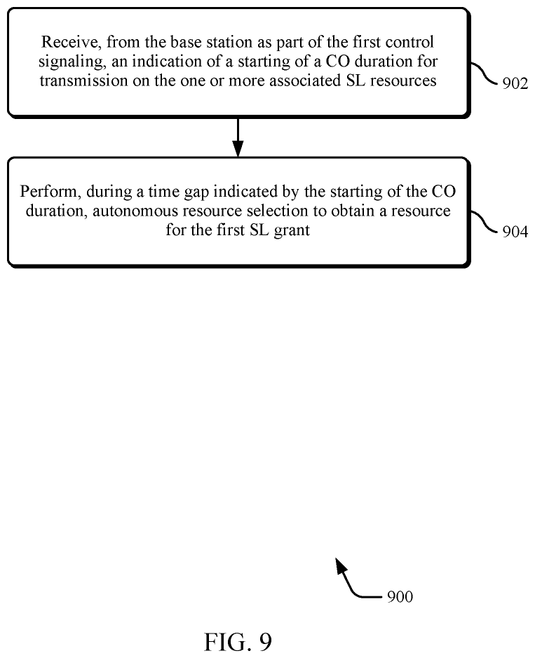

FIG. 9 illustrates a flowchart of a method 900 that supports managing sidelink feedback to a base station in accordance with aspects of the present disclosure. The operations of the method 900 may be implemented and performed by a device or its components, such as a UE 104 or UE 202 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 902, the method may include receiving, from the base station as part of the first control signaling, an indication of a starting of a CO duration for transmission on the one or more associated SL resources. The operations of 902 may be performed in accordance with examples as described herein. In some implementations, aspects of the operations of 902 may be performed by a device as described with reference to FIG. 1 or FIG. 2.

At 904, the method may include performing, during a time gap indicated by the starting of the CO duration, autonomous resource selection to obtain a resource for the first SL grant. The operations of 904 may be performed in accordance with examples as described herein. In some implementations, aspects of the operations of 904 may be performed by a device as described with reference to FIG. 1 or FIG. 2.

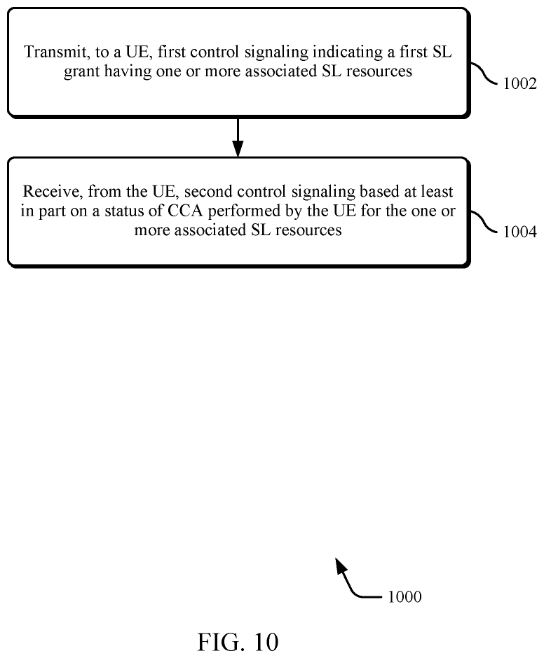

FIG. 10 illustrates a flowchart of a method 1000 that supports managing sidelink feedback to a base station in accordance with aspects of the present disclosure. The operations of the method 1000 may be implemented and performed by a device or its components, such as a base station 102 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 1002, the method may include transmitting, to a UE, first control signaling indicating a first SL grant having one or more associated SL resources. The operations of 1002 may be performed in accordance with examples as described herein. In some implementations, aspects of the operations of 1002 may be performed by a device as described with reference to FIG. 1.

At 1004, the method may include receiving, from the UE, second control signaling based at least in part on a status of CCA performed by the UE for the one or more associated SL resources. The operations of 1004 may be performed in accordance with examples as described herein. In some implementations, aspects of the operations of 1004 may be performed by a device as described with reference to FIG. 1.

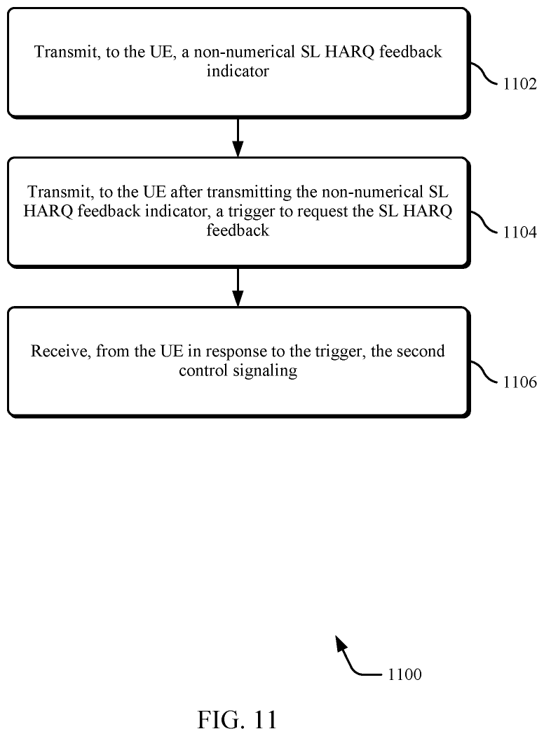

FIG. 11 illustrates a flowchart of a method 1100 that supports managing sidelink feedback to a base station in accordance with aspects of the present disclosure. The operations of the method 1100 may be implemented and performed by a device or its components, such as a base station 102 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 1102, the method may include transmitting, to the UE, a non-numerical SL HARQ feedback indicator. The operations of 1102 may be performed in accordance with examples as described herein. In some implementations, aspects of the operations of 1102 may be performed by a device as described with reference to FIG. 1.

At 1104, the method may include transmitting, to the UE after transmitting the non-numerical SL HARQ feedback indicator, a trigger to request the SL HARQ feedback. The operations of 1104 may be performed in accordance with examples as described herein. In some implementations, aspects of the operations of 1104 may be performed by a device as described with reference to FIG. 1.

At 1106, the method may include receiving, from the UE in response to the trigger, the second control signaling. The operations of 1106 may be performed in accordance with examples as described herein. In some implementations, aspects of the operations of 1106 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of′) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first user equipment (UE) for wireless communication, comprising:
at least one memory; and
at least one processor coupled with the at least one memory and configured to cause the first UE to:
receive, from a base station, first control signaling indicating a first sidelink (SL) grant having one or more associated SL resources;
perform clear channel assessment (CCA) for the one or more associated SL resources;
include, in response to the CCA failing for the one or more associated SL resources, a non-acknowledgement (NACK) in a hybrid automatic repeat request (HARQ) feedback;
transmit, to the base station, the HARQ feedback.

2. The first UE of claim 1, wherein the at least one processor is further configured to cause the first UE to perform, in response to the one or more SL resources not being included in the first SL grant or the one or more SL resources being outside a remaining channel occupancy (CO) determination, autonomous resource selection to obtain a resource for the first SL grant.

3. The first UE of claim 1, wherein the at least one processor is further configured to cause the first UE to transmit, in response to a physical sidelink feedback channel (PSFCH) not being received from a second UE via the one or more SL resources before a physical uplink control channel (PUCCH) resource is to transmit the HARQ feedback to the base station, a discontinuous transmission (DTX) in the HARQ feedback.

4. The first UE of claim 1, wherein the at least one processor is further configured to cause, in response to a physical sidelink feedback channel (PSFCH) not being received from a second UE via the one or more SL resources before a physical uplink control channel (PUCCH) resource is to transmit the SL HARQ feedback to the base station, the first UE to:
transmit the NACK in the HARQ feedback;
receive, from the base station, a second control signaling indicating a second SL grant; and
ignore, in response to the PSFCH being received from the second UE via the one or more SL resources after the HARQ feedback is transmitted to the base station, the second SL grant.

5. The first UE of claim 1, wherein the HARQ feedback is included in a first physical uplink control channel (PUCCH) resource indicating a first status of the CCA if the CCA failed for the one or more SL resources, or in a second PUCCH resource indicating a second status of the CCA if a decoding failure of SL data occurred.

6. The first UE of claim 1, wherein the first SL grant identifies one or more of the associated SL resources, a channel occupancy time (COT) sharing indicator, or a remaining channel occupancy (CO) duration.

7. (canceled)

8. (canceled)

9. The apparatus first UE of claim 1, wherein the at least one processor is further configured to cause the UE, in response to the CCA failing for the one or more SL resources, to:
receive, from the base station in response to the HARQ feedback, a second SL grant.

10. The first UE of claim 1, wherein the at least one processor is further configured to cause the first UE, in response to the first SL grant identifying a channel occupancy time (COT) sharing indicator and the one or more associated SL resources, to perform Cat 2 listen before talk (LBT) as the CCA.

11. The first UE of claim 1, wherein the at least one processor is further configured to cause the first UE, in response to the first SL grant not identifying the one or more associated SL resources, to perform autonomous resource selection to obtain a resource for the first SL grant within a remaining channel occupancy (CO) duration.

12. The first UE of claim 1, wherein the at least one processor is further configured to cause, in response to a physical sidelink feedback channel (PSFCH) not being received from a second UE via the one or more SL resources before a physical uplink control channel (PUCCH) resource is to transmit the HARQ feedback to the base station, the first UE to:
transmit the NACK in the HARQ feedback;
receive, from the base station, a second control signaling indicating a second SL grant; and
transmit a new transmission, in response to the PSFCH not being received from the second UE via the one or more SL resources, to the second UE via one or more SL resources associated with the second SL grant.

13. The first UE of claim 1, wherein the at least one processor is further configured to cause, in response to a physical sidelink feedback channel (PSFCH) not being received from a second UE via the one or more SL resources before a first physical uplink control channel (PUCCH) resource is to transmit the HARQ feedback to the base station, the first UE to transmit, in a second PUCCH resource, the HARQ feedback indicating a delay in reception of the PSFCH.

14. The first UE of claim 1, wherein the at least one processor is further configured to cause the first UE to:
receive, from the base station, a non-numerical HARQ feedback indicator;
receive, from the base station after receiving the non-numerical HARQ feedback indicator, a trigger to request the HARQ feedback; and
transmit, to the base station in response to the trigger, the SL HARQ feedback.

15. The first UE of claim 1, wherein the at least one processor is further configured to cause the first UE to:
receive, from the base station as part of the first control signaling, an indication of a starting of a channel occupancy (CO) duration for transmission on the one or more associated SL resources; and
perform, during a time gap indicated by the starting of the CO duration, autonomous resource selection to obtain a resource for the first SL grant.

16. A base station for wireless communication, comprising:
at least one memory; and
at least one processor coupled with the at least one memory and configured to cause the base station to:
transmit, to a user equipment (UE), first control signaling indicating a first sidelink (SL) grant having one or more associated SL resources; and
receive, from the UE, a non-acknowledgement (NACK) in a hybrid automatic repeat request (HARQ) in a first physical uplink control channel (PUCCH) resource if clear channel assessment (CCA) failed for the one or more associated SL resources.

17. (canceled)

18. The base station of claim 16, wherein the at least one processor is further configured to cause the base station to:
transmit, to the UE, a non-numerical HARQ feedback indicator;
transmit, to the UE after transmitting the non-numerical HARQ feedback indicator, a trigger to request the HARQ feedback; and
receive, from the UE in response to the trigger, the HARQ feedback.

19. A method performed by a user equipment (UE), the method comprising:
receiving, from a base station, first control signaling indicating a first SL grant having one or more associated SL resources;
performing a CCA for the one or more associated SL resources; and
including, in response to the CCA failing for the one or more SL resources, a non-acknowledgement (NACK) in a hybrid automatic repeat request (HARQ) feedback; and
transmitting, to the base station, the HARQ feedback.

20. The method of claim 19, further comprising performing, in response to the one or more SL resources not being included in the first SL grant or the one or more SL resources being outside a remaining channel occupancy (CO) determination, autonomous resource selection to obtain a resource for the first SL grant.

21. A processor for wireless communication, comprising:
at least one controller coupled with at least one memory and configured to cause the processor to:
receive, from a base station, first control signaling indicating a first sidelink (SL) grant having one or more associated SL resources;
perform clear channel assessment (CCA) for the one or more associated SL resources;
include, in response to the CCA failing for the one or more SL resources, a non-acknowledgement (NACK) in a hybrid automatic repeat request (HARQ) feedback;
transmit, to the base station, the HARQ feedback.

22. The processor of claim 21, wherein the at least one controller is further configured to cause, in response to a physical sidelink feedback channel (PSFCH) not being received from a user equipment (UE) via the one or more SL resources before a physical uplink control channel (PUCCH) resource is to transmit the HARQ feedback to the base station, the processor to:
transmit the NACK in the HARQ feedback;
receive, from the base station, a second control signaling indicating a second SL grant; and
ignore, in response to the PSFCH being received from the UE via the one or more SL resources after the HARQ feedback is transmitted to the base station, the second SL grant.

23. The processor of claim 21, wherein the at least one controller is further configured to cause the processor, in response to the CCA failing for the one or more SL resources, to:
receive, from the base station in response to the HARQ feedback, a second SL grant.
